(19) United States
(12) Patent Application Publication
(10) Pub. No.: US 2014/0101289 A1
(43) Pub. Date: Apr. 10, 2014

(54) METHODS AND SYSTEMS FOR SELECTING DEVICE APPLICATIONS

(71) Applicant: Agile Fusion Corporation, Pleasanton, CA (US)

(72) Inventors: Anton Antonov, Saint Petersburg (RU); Alexey Krasnoriadtsev, Pleasanton, CA (US)

(73) Assignee: Agile Fusion Corporation, Pleasanton, CA (US)

(21) Appl. No.: 14/026,249

(22) Filed: Sep. 13, 2013

Related U.S. Application Data
(60) Provisional application No. 61/711,360, filed on Oct. 9, 2012.

(51) Int. Cl. H04L 12/24

(52) U.S. Cl. CPC H04L 41/0253
USPC 709/218

(57) ABSTRACT

Provided are methods and systems for selecting applications available on client devices for displaying content. A client device requesting content is directed to a server using a shortcut uniform resource locator (URL). Each shortcut URL may be linked to a corresponding application URL and/or a webpage URL. Application URLs are configured to be opened by non-browser applications on client devices. In response to the client device request, the server selects application and/or webpage URLs and transmits these URLs to the client device. Both an application URL and a webpage URL may be packed into a determination module transmitted to the client device. If an application requested by the application URL is available on the client device, the device proceeds with opening this application and presenting the requested content though this application interface. Alternatively, the device uses the webpage URL to view content through the browser interface.

### CROSS-REFERENCE TO RELATED APPLICATIONS

This application claims the benefit under 35 U.S.C. §119(e) of US Provisional Patent Application No. 61/711,360, entitled: “METHODS AND SYSTEMS FOR SELECTING DEVICE APPLICATIONS” filed on 9 Oct. 2012 (Attorney Docket No. AGLFP001P), which is incorporated herein by reference in its entirety.

### BACKGROUND

Web content and other types of content may be viewed using web browsers or specific applications distributed by content providers and other parties. For example, an online retailer, Amazon, has a full webpage, a mobile version of its webpage (i.e., mobile webpage), and a number of applications for viewing generally the same content that is available on the webpages, e.g., Amazon Mobile, Amazon MP3, Price Check by Amazon, and others. Applications developed for viewing content from a content provider may be supplied and/or authorized by the provider or some other third party. For example, various third party applications may be used for interacting with Amazon. Furthermore, applications for viewing content may be used on mobile devices (e.g., personal digital assistants (PDAs), enterprise digital assistants (EDAs), and/or mobile phones) and other types of computer systems, e.g., laptops, tablets, desktops, and the like. The invention described herein is not limited to any types of applications or computer systems.

### SUMMARY

Provided are methods and systems for selecting applications available on client devices for displaying content. A client device requesting content is directed to a server using a shortcut uniform resource locator (URL). Each shortcut URL may be linked to a corresponding application URL and/or a webpage URL. Application URLs are configured to be opened by non-browser applications on client devices. In response to the client device request, the server selects application and/or webpage URLs and transmits these URLs to the client device. Both an application URL and a webpage URL may be packed into a determination module transmitted to the client device. If an application requested by the application URL is available on the client device, the device proceeds with opening this application and presenting the requested content though this application interface. Alternatively, the device uses the webpage URL to view content through the browser interface.

In some embodiments, a method for selecting an application for displaying content involves receiving a request from a client device. The request includes a shortcut URL. The method proceed with retrieving an application URL and a webpage URL corresponding to the shortcut URL and generating a determination module. The determination module includes the retrieved application URL and the webpage URL. The method then proceeds with transmitting the determination module to the client device.

In some embodiments, the determination module includes a URL selection logic configured to retrieve, at the client device, the application URL and the webpage URL according to one or more rules. The one or more rules may include instructions for retrieving the application URL when the determination module is received at the client device. The one or more rules may include instructions for retrieving the webpage URL after retrieving the application URL and after receiving an error message from the client device. In some embodiments, the one or more rules may include instructions for retrieving the webpage URL at a time period after retrieving the application URL. The one or more rules may include instructions for retrieving the webpage URL (a) at a time period after retrieving the application URL or (b) after retrieving the application URL and after receiving an error message from the client device. Furthermore, the one or more rules may include instructions for retrieving the webpage URL (a) at a predetermination time after retrieving the application URL and (b) after retrieving the application URL and after receiving an error message from the client device.

In some embodiments, the determination module is implemented in one of Java script, lash/Application script, browser plugin, or Visual Basic (VB) script. The determination module may be configured to execute the application URL on a foreground of a user interface of the client device and may be further configured to execute the webpage URL on a background of the user interface of the client device.

In some embodiments, the application URL is a mobile application URL and the webpage URL is a mobile webpage URL. The method may also involve retrieving a non-mobile application URL and a non-mobile webpage URL corresponding to the shortcut URL. In these embodiments, the determination module may also include the retrieved non-mobile application URL, the non-mobile webpage URL, and URL selection logic. The logic is configured to select among the mobile application URL, the mobile webpage URL, the non-mobile application URL, and the non-mobile webpage URL.

Provided also is a method for selecting an application for displaying content. The method may involve receiving a request from a client device such that the request includes a shortcut URL. The method proceeds with retrieving an application URL corresponding to the shortcut URL, transmitting the application URL to the client device, determining if an error code is received from the client device and, if the error code is received, retrieving and transmitting a webpage URL corresponding to the service provider URL. It should be noted that the application URL is first transmitted without the webpage URL. The webpage URL is transmitted to the client device only upon receipt of the error code from the client device.

The shortcut URL, the application URL, and the webpage URL are stored in a database. The database includes multiple different application URLs and multiple webpage URLs associated with different content providers.

In some embodiments, the method also involves directing the client device to an external database having an application corresponding to the mobile application URL, if the error code is received. For example, an error code may be generated and transmitted by the client device if an application capable of executing the application URL is not available on the device. In this case, the client device may be directed to the external database (e.g., App Store or Google Play) that may have this application available. A link to a specific application may be provided rather than a general link to the database containing multiple different applications.

In some embodiments, receiving a request from the client device, retrieving an application URL corresponding to the shortcut URL, transmitting the application URL to the client device, determining if an error code is received from the client device, and, optionally, retrieving and transmitting a webpage URL corresponding to the service provider URL are repeated at least once. For example, a client device may send a new request with a different shortcut URL to the server.

In some embodiments, the method also involves determining from the received request if the client device is a mobile device. If it is determined that the client device is not the mobile device, a non-mobile webpage URL is transmitted and retrieving an application URL corresponding to the shortcut URL, transmitting the application URL to the client device, determining if an error code is received from the client device, and retrieving and transmitting a webpage URL corresponding to the service provider URL are not performed. The method may also involve receiving a plurality of application URLs and a plurality of webpage URLs and generating a corresponding plurality of shortcut URLs. The application URLs and the webpage URLs may come from content providers. In some embodiments, the method also involves retrieving and transmitting the webpage URL corresponding to the service provider URL after a period of time after transmitting the application URL to the client device. In these embodiments, the webpage URL may be transmitted even if the error message is not received from the client.

Provided also is a service provider system for performing a method for selecting an application for displaying content. The service provider system may include a communication module for receiving a request and an error message from a client device such that the request includes a shortcut URL, a client detection module for detecting if the client device is a mobile device, an application detection module for retrieving an application URL corresponding to the shortcut URL or a webpage URL corresponding to the shortcut URL, and a URL database comprising the shortcut URL, the application URL, and the webpage URL. In some embodiments, the service provider system has fewer modules or more modules. For example, the client detection module may not be present.

Provided also is a machine readable medium having embodied thereon executable code. The executable code may be executed by a processor for performing a method for selecting an application for displaying content. The machine readable medium includes a code for receiving a request from a client device such that the request containing a shortcut URL, a code for retrieving a application URL corresponding to the shortcut URL, a code for transmitting the application URL to the client device, a code for determining if an error code is received from the client device, and a code for based on the determination, if the error code is received, retrieving and transmitting a webpage URL corresponding to the service provider URL.

Finally provided is a service provider system for performing a method for selecting an application for displaying content. The service provider system may include means for receiving a request from a client device such that the request containing a shortcut URL, means for retrieving an application URL corresponding to the shortcut URL, means for transmitting the application URL to the client device, means for determining if an error code is received from the client device, and means for based on the determination, if the error code is received, retrieving and transmitting a webpage URL corresponding to the service provider URL.

### BRIEF DESCRIPTION OF THE DRAWINGS

FIG. 1 is a schematic representation of a service environment for implementing methods and systems for selecting applications available on client devices to display requested content, in accordance with some embodiments.

FIG. 2A is a schematic representation of service provider system, in accordance with some embodiments.

FIG. 2B is a schematic example of a determination module, in accordance with some embodiments.

FIG. 3A is a process flowchart corresponding to a method of selecting an application available on the client device for viewing content, in accordance with some embodiments.

FIG. 3B is a process flowchart corresponding to a method of selecting an application available on the client device based on a URL received on the client device, in accordance with some embodiments.

FIG. 3C is a schematic process flowchart corresponding to a method for generating and processing shortcut URLs, in accordance with some embodiments.

FIG. 3D is a schematic process flowchart corresponding to a method implemented on a determination module, in accordance with some embodiments.

FIG. 4 shows a diagrammatic representation of a computer system (e.g., a client device or a service provider system), within which a set of instructions for causing the system to perform one or more of the methodologies discussed herein.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as to not unnecessarily obscure the described concepts. While some concepts will be described in conjunction with the specific embodiments, it will be understood that these embodiments are not intended to be limiting.

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, and other embodiments can be formed, by introducing structural and logical changes without departing from the scope of what is claimed. The following detailed description is, therefore, not to be taken in a limiting sense and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

### Introduction

While popularity and number of mobile and non-mobile applications continues to rise, use of these applications becomes more difficult. Often users do not know about existence of particular applications in application ecosystems (e.g., Google Play Store). In many cases, users are not even aware when some of these applications are installed on their own devices. For example, millions of mobile applications are available from the Google Play Store, the App Store, and other like services. New applications are added at a rate of tens of thousands each month. Furthermore, consumer reports have indicated that an average smartphone user has over 100 applications on his or her smartphone and downloads about 40-80 applications each year. It cannot be expected that a user can keep a track of all available applications either on his or her device or the application ecosystem.

Content providers and users can benefit if specific applications are used for viewing particular content than when the same content is viewed using generic browser. Non-browser applications are designed with specific content in mind, while browsers have to handle all types of contents presented as webpages. While webpages became a popular common medium for presenting content, a much richer experience can be provided to users with content specific applications than with generic browsers.

Content specific applications may be either manually selected by users from libraries of applications available on client devices or automatically activated by application URLs. Unlike a webpage URL, which activates a web browser and directs the web browser to retrieve the content from a content provider and displays this content on the browser interface, an application URL activates a specific application other than the browser and directs this application to retrieve the content from the content provider and then displays this content on the application interface. While the content retrieved in both instances may be the same or substantially the same, the application interface may be more suitable for displaying this content. It should be noted that different application URLs may activate different applications available on the same client device, while different webpage URLs typically activate the same browser on the client device, e.g., a default browser if multiple browsers are available on the same device.

Content providers are reluctant to transmit application URLs to users in many situations because many devices may not have corresponding applications. If an application URL is activated on a device that does not have a corresponding application, user experience may be significantly deteriorated. For example, the device may show an error message or have no response to the application URL at all. Often, an error message is presented without any apparent options on how to address this message and still retrieve the desired content. Users highly dislike seeing error messages, broken links, and other disruptions during their content viewing experience. As a result, content providers resort to very limited use of application URLs, for example, when availability of corresponding applications is confirmed. In general, webpage URLs continue to dominate the ecosystem without providing enriched content viewing experience available from use of specific applications and application URLs.

Provided are methods and systems that allow selecting between application URLs and webpage URLs depending on availability of particular applications on client devices. Furthermore, the methods and systems may be configured to differentiate between mobile and non-mobile devices and select appropriate application URLs and webpage URLs. The application URLs and webpage URLs may be linked to corresponding shortcut URLs that are transmitted to the client devices and used by the client devices to request content. For example, a shortcut URL may be used by a client device to generate a content request. The request may be transmitted to and processed by a service provider, which may be an entity different form the content provider. The service provider then retrieves an application URL and/or a webpage URL corresponding to the shortcut URL and sends this URL to the client device.

In some embodiments, both application URL and webpage URL are retrieved and packed into a determination module. The determination module may be in a form of a Java script, Flash/Action script, browser plugin, or Visual Basic script. The determination module containing multiple URLs is transmitted to the client device requesting the content. The determination module then retrieves an appropriate URL for the client device to use based on, e.g., availability of a particular application on the client device.

If only one URL transmitted to the client device (e.g., the determination module is not used), then this URL is typically the application URL. The client device first uses the application URL and depending on the response of the client device (e.g., an error message) switches to the webpage URL (e.g., the webpage URL is transmitted to the client device). When multiple URLs are packed into the determination module, this switching may be performed by the determination module that retrieves the previously transmitted webpage URL or by requesting the webpage URL from the service provider.

An example may help to clarify some features of these methods and systems. A content provider may have one or more webpages (e.g., a regular webpage and a mobile webpage) and one or more applications (e.g., a non-mobile application and a mobile application) that are designed to present the same or similar content. For purposes of this disclosure, a content provider is defined as any entity that is interested in delivering its content to a user. The content may be supplied by the content provider or some other third party entity. In general, the methods and systems are applicable to all kinds of webpages and applications. In some embodiments, the methods and systems are capable of distinguishing between mobile and non-mobile applications and between regular and mobile webpages based on identifiers received from client devices.

Continuing with the above example, the content provider may request a shortcut URL from a service provider corresponding to the content in question. This request may follow receiving instructions from the client device. For example, a first user may choose certain content for sharing with a second user. However, the first user is not aware which device (e.g., a mobile device or a non-mobile device) the second user will use to view this content. Furthermore, the second user may typically not be aware and if a specific application is available on this second device for viewing this content. As such, the first user may not know what kind of URL should be transmitted to the second user, e.g., a mobile application URL, a non-mobile application URL, a mobile webpage URL, or a non-mobile application URL. In some embodiments, the content provider and the service provider may be the same entity.

The shortcut URL generated by the service provider may be linked to one or more application URLs and one or more webpage URLs, e.g., the same shortcut URL is linked to a mobile application URL, a non-mobile application URL, a mobile webpage URL, and a non-mobile application URL. Various other subsets of these four URLs may be used as well. The shortcut URL may be created dynamically, e.g., after receiving a request from the content provider, or ahead of time, in which case, the shortcut URLs is retrieved from a database containing previously created shortcut URLs. In either case, the shortcut URL may be later kept in a database of the service provider together with corresponding application and webpage URLs for future uses. Furthermore, the shortcut URL is transmitted to the content provider for distribution or directly to the user.

Returning to the above example, the first user may then transmit this shortcut URL to the second user. This transmission may be performed using any medium, such as an e-mail, a text message, and the like medium. At that time, the shortcut URL may be used by any device connected to the service provider. Depending on the device and applications available on this device, the shortcut URL will be used to retrieve a corresponding application URL or a corresponding webpage URL. In some embodiments, the same shortcut URL may be used to retrieve a mobile application URL, a non-mobile application URL, a mobile webpage URL, or a non-mobile application URL. For example, the second user may use its mobile phone to activate the shortcut URL. If this mobile device has a corresponding application, then a mobile application URL may be used to activate this application and retrieve this content. If the application is not available, then a mobile webpage URL may be used to activate a browser (e.g., a mobile browser) and retrieve the content. Alternatively or in addition to using the mobile phone, the second user may access this shortcut URL using a non-mobile device, e.g., a laptop. In this case, if this non-mobile device has a corresponding application, then a non-mobile application URL may be used to activate this application and retrieve this content. On the other hand, if the application is not available, then a non-mobile webpage URL may be used to activate a browser and retrieve the content.

Retrieval of corresponding application and webpage URLs based on activation of a shortcut URL may involve creating a determination module that includes different URLs and transmitting this module to a client device for retrieval of one or more URLs from the determination module. The determination module may include a URL selection logic for selecting appropriate URLs based on various factors, such as a type of the client device and/or availability of a particular application on the client device.

For example, the determination module may first select the application URL from the module and instruct the client device to access the content using this URL. If this attempt is successful (i.e., a specific application corresponding to this application URL is available on the client device), then the content is retrieved and the process is completed. In some embodiments, the content may be also loaded using a browser, but this is performed on the background and is not visible to the user. However, if the attempt of using he application URL to retrieve the content is not successful, the client device may generate an error message (as e.g., for Android operating systems) or not (as, e.g., for iOS operating systems). In case of the error message, the determination module may retrieve the webpage URL and instruct the web browser to use this webpage URL to retrieve the content. On the other hand, if no error messages are generated, the determination module may use its own built-in counter to wait for a response (e.g., an error message) and then retrieve the webpage URL and initial the web browser. The wait may be timed, e.g., proceed for a predetermined period of time. The browser may be opened on a background and, therefore, if the application has already opened, opening of the browser will not interfere with viewing the content using the application.

In some embodiments, application and webpage URLs may be sent sequentially to the client device, i.e., first an application URL sent to the device followed by the webpage URL. Transmission of the webpage URL maybe triggered by the error message or timeout. Specifically, when a client device activates a shortcut URL, the service provider first transmits one of the application URLs. If the client device has an application that can be activated by this transmitted application URL, then the application is activated and the process proceeds with the application retrieving the content from the content provider. The retrieved content is then presented on the device using the application interface. On the other hand, if the application is not available on the client device, then the client device may transmit an error message to the service provide indicating that the application is not available. In response to receiving this error message, the service provider transmits one of the webpage URLs for retrieving a webpage using a browser provided on the client device. The client device then downloads the webpage content from a service provider and displays this content in the browser. In some embodiments, the service provider and the content provider are different entities having their own computer systems that maintain communication with the client device. Functions of the service provider and the content provider may be clearly distinct. In other embodiments, some functions (e.g., maintaining correspondence table) of the service provider may be performed by the content provider.

### Examples of Service Environment

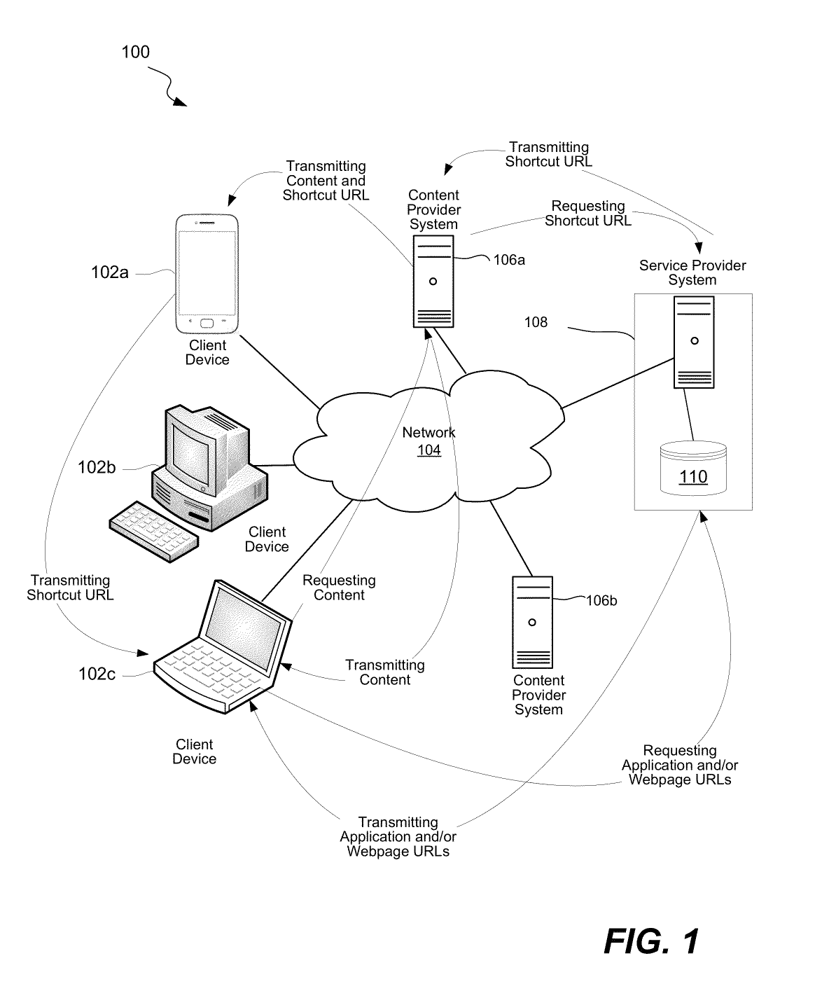

FIG. 1 is a schematic representation of a service environment 100 for implementing methods and systems for selecting applications available on client devices 102a-102c to display requested content, in accordance with some embodiments. Service environment 100 is shown to include multiple client devices 102a-102c, service provider system 108, and content provider systems 106a-b. The systems and devices of service environment are communicatively coupled using a network 104 allowing transmission of requests, URLs, modules, and other information among the systems and devices.

Client devices 102a-102b may be mobile devices such as smartphones, tablets, PDA, and other like devices, or fully functional computer systems, such as desktops and laptops. For purposes of this disclosure, mobile devices are defined as devices having mobile operating systems (mobile OS), such as Android from Google Inc., BlackBerry OS from RIM, iOS from Apple Inc.S40 (Series40) from Nokia, webOS from HP, Symbian OS from Nokia and Accenture, bada from Samsung Electronics, and Windows Phone from Microsoft. Other mobile operating systems are also within the scope of this disclosure. Fully functional computer systems are defined as computer systems that have non-mobile operating systems, such as Linux, Mac OS, and Windows. Unless specifically noted, the methods and systems described herein are applicable to all types of client devices, e.g., mobile and fully functional. For purposes of this disclosure, fully-functional computer systems are often referred to as non-mobile computer systems, even though such systems may be still physically mobile (e.g., laptops). The mobile v. non-mobile distinction is generally superficial and generally depends on operating systems used by client devices.

Client devices that are mobile may include mobile browsers, such as Android browser, BlackBerry browser, Blazer, Dolphin browser, Firefox for mobile, Internet Explorer mobile, Iris Browser, Kindle Basic Web, and the like. A mobile browser is a web browser specifically designed for use on a mobile device. Mobile browsers may be optimized so as to display content most effectively for small screens on the mobile devices. Mobile browser software may be small and efficient to accommodate the low memory capacity and low-bandwidth of the mobile devices. Webpages designed for access from these browsers are referred to as wireless portals. Their URLs are referred to as mobile webpage URLs. It should be noted that many devices having mobile operating systems and browsers often have displays, memory, processing speed, and other characteristics that are compatible and often superior to that of non-mobile devices. The distinction between mobile and non-mobile devices is gradually erased.

Client devices may be configured to store and run applications, e.g., mobile applications and non-mobile applications. A mobile application (or a mobile app) is a software application specifically designed to run on a mobile device. These applications are available through application distribution platforms, which are typically operated by the owner of the mobile operating system, such as the Apple App Store, Google Play, Windows Phone Marketplace and BlackBerry App World. Usually, mobile applications are downloaded from the platform to mobile devices, but sometimes they can be downloaded to fully functional computer systems, such as laptops or desktops. The non-mobile applications are typically shared directly by application developers and content providers. However, distribution platforms are also being used to provide these applications to client devices.

Network 104 may take any suitable form, such as a wide area network or Internet and/or one or more local area networks (LAN's). Network 104 may include any suitable number and type of devices, e.g., routers and switches, for forwarding commands, content, and/or web object requests from each user to the online community application and responses back to the users.

The systems and methods describe herein may also be practiced in a wide variety of network environments including, for example, TCP/IP-based networks, telecommunications networks, wireless networks, etc. In addition, the computer program instructions may be stored in any type of computer-readable media. The program may be executed according to a variety of computing models including a user/server model, a peer-to-peer model, on a stand-alone computing device, or according to a distributed computing model in which various functionalities described herein may be effected or employed at different locations.

The service environment 100 may also include service provider system 108 for creating shortcut URLs and, in some embodiments, handling requests associated with these shortcut URLs. For example, service provider systems 108 may include a database 110 that stores the shortcut URLs and corresponding application URLs and webpage URLs. Each shortcut URL may correspond to at least one application URL and at least one webpage URL. In some embodiments, a shortcut URL may have multiple corresponding application URLs and/or multiple corresponding webpage URLs. For example, a shortcut URL may correspond to a non-mobile application URL, a mobile application URL, a mobile webpage URL, and a non-mobile webpage URL.

Service provider system 108 is configured to receive requests from content provider systems 106a-b to generate shortcut URLs. These operations may be performed dynamically. For example, a client device (e.g., 102a) may be used to view content provided by a content provider system (e.g., 106a). There may be no shortcut URL associated with this content. When the client device requests to share this content with another user (e.g., a user of client device 102b), the client device or the content provider system may send a request to service provider system 108 to generate a shortcut URL for this content. As a part of this request, the content provider system may transmit one or more corresponding application URLs and one or more webpage URLs. Service provider system 108 generates a shortcut URL and, in some embodiments, stores this shortcut URL and corresponding application and webpage URLs in database 110 for future uses. Service provider system 108 then transmits this shortcut URL to the content provider system, which in turns transmit this shortcut URL to the requesting client device. In some embodiments, service provider system 108 transmits requests directly to the client device. The client device then transmits this shortcut URL to the other client device, with which the content is shared. When this other client device triggers the shortcut URL, it is directed to service provider system 108, which in turn retrieves the stored application and webpage URLs and transmits these URLs to this other client device. These application and webpage URLs are then used by this other client device to retrieve the content from the content provider system. Other features of these processed are described below with reference to corresponding process flowcharts.

Content provider systems 106a-b may provide content to client devices 102a-102c when requests corresponding to application URLs and/or webpage URLs are received from client devices 102a-102c. In some embodiments, the same content is used for corresponding application and webpage URLs (i.e., application and webpage URLs corresponding to one shortcut URL). In other embodiments, this content is different, i.e., one content is supplied when a request corresponding to the application URL is received and other content is supplied when a request corresponding to the webpage URL is received, even though these application and webpage URLs correspond to one shortcut URL.

In some embodiments, multiple content provider systems are supported by the same service provider system. Furthermore, one content provider may utilize multiple service provider systems.

### Examples of Service Provider Systems

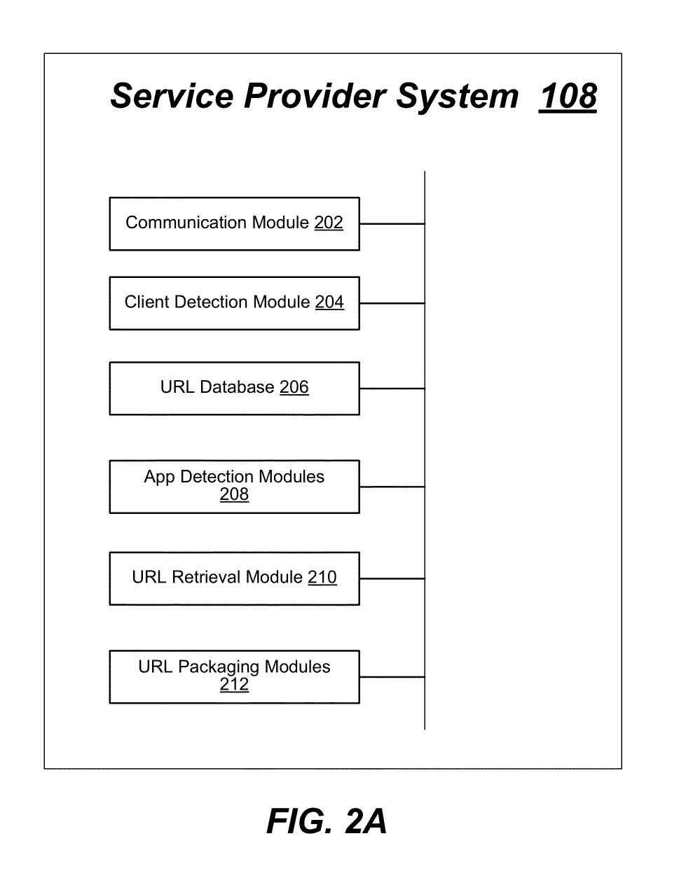

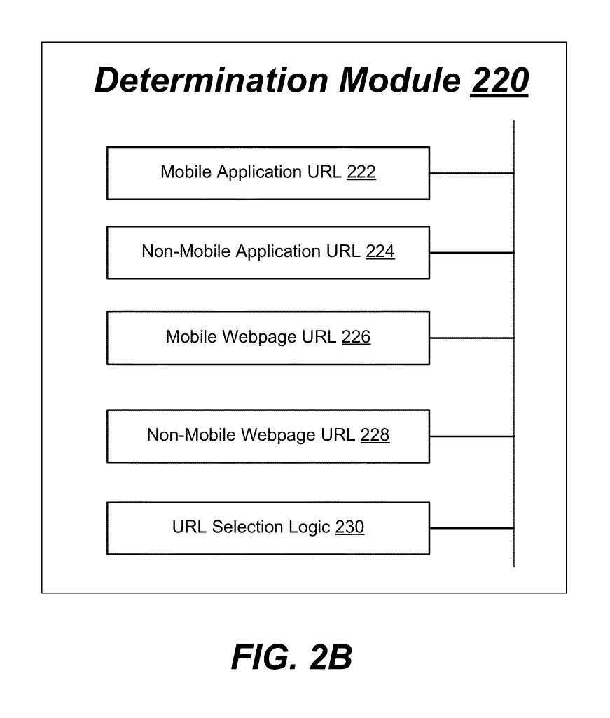

FIG. 2A is a schematic representation of service provider system 108, in accordance with some embodiments. Service provider system 108 may include a communication module 202, client detection module 204, URL database module 206 (or simply URL database 206), application detection module 208, and URL retrieval module 210, and URL packaging module 212. Other modules may be included as well. In some embodiments, fewer modules may be used to achieve the same functionality or other functionality. The modules may be implemented in software and/or hardware.

Communication module 202 receives request from one or more client devices and/or content provider servers. Furthermore, communication module 202 transmits application and/or webpage URLs and/or determination modules containing these application URLs and/or webpage URLs to the client devices and/or the content provider servers. Communication module 202 may also perform other communication function (e.g., authentication, and the like). These application and/or webpage URLs may be retrieved from URL database 206 by other modules of service provider system 108, e.g., by URL retrieval module 210. In some embodiments, the retrieved URLs may be packaged into determination modules (to be transmitted to client devices) by URL packaging module 212.

Client detection module 204 is used to detect whether the request is transmitted to by a mobile device or by a non-mobile device (i.e., fully functional computer system). The distinctions between these types of devices are presented above and are generally based on the type of operating systems available on these devices. Client detection module 204 may be operable in a manner similar to a module used to redirect devices to a mobile webpage site from a standard webpage if it is detected that a device sending a request is one of the mobile devices. For example, a JavaScript may be used for browser detection. Alternatively, client detection module 204 may have a code implemented in e.g., PHP, ASP, JSP, ColdFusion, to look at a user-agent that generated the request and make necessary detection. An example of a PHP code is presented below:

```
<? if (
  stristr($ua, “Windows CE”) or
  stristr($ua, “AvantGo”) or
  stristr($ua,“Mazingo”) or
  stristr($ua, “Mobile”) or
  stristr($ua, “Blazer”) ) {
  $DEVICE TYPE=“MOBILE”;
  }
  if (isset($DEVICE_TYPE) and $DEVICE_TYPE==“MOBILE”) {...
```

In some embodiments, service provider system 108 does not include client detection module 208 or other like modules. The feature differentiating between mobile and non-mobile devices may be omitted or implemented at a client device level. For example, URL packaging module 212 may yield a determination module, which is transmitted to the client device and used by the client device to select between mobile and non-mobile URLs. In this case, the service provider system 108 is not concern with the type of client devices.

URL database 206 holds various data, such as shortcut URLs and corresponding application URLs and webpage URLs. URL database 206 may include a table, in which each shortcut URL corresponds to one application URL and one webpage URL. An example of two table entries is presented below:

TABLE

| Shortcut URL | Application URL | Webpage URL |
|---|---|---|
| http://afurl.com/ | macyapp://productdetails/? | http://m.macys.com/shop/product/le |
| XYZ | product=70917 | vis-jeans-505-straight-leg?ID=70917 |
| http://afurl.com/ | nordstromapp://productdeta | http://m.nordstrom.com/shop/s/levis- |
| ABC | ils/?product=3351104 | 505-bedford-slim-straight-leg- |
| | | pants/3351104 |

As stated above, the table may include multiple webpage URLs (e.g., one corresponding to a mobile webpage and another corresponding to a non-mobile webpage) corresponding to one shortcut URL. The table may also include multiple application URLs (e.g., one corresponding to a mobile application and another corresponding to a non-mobile application). As such, when a device is determined to be a non-mobile device by client detection module 204, a non-mobile application URL and/or a non-mobile webpage URL is sent to the device. Alternatively, when a device is determined to be a mobile device, a mobile application URL is initially transmitted to the device. If an error message is returned by the device, then the process may continue with transmitting with a mobile webpage URL. If the error message is not transmitted, the process may be aborted after transmitting the mobile webpage URL.

Another function of URL database 206 may be to generate shortcut URLs corresponding to received application and webpage URLs. In some embodiments, shortcut URLs are “blinded” URLs meaning that these shortcut URLs have no indication of content or content providers associated with these URLs. In other embodiments, shortcut URLs have some indications of associated content and/or content provider. In other embodiments, shortcut URLs are generated by another module. The shortcut URLs may be linked to new application and/or webpage URLs if, for example, these URLs are changed by the content provider. The shortcut URLs may be maintained for predetermined period of time by the service provider.

Application detection module 208 determines if a webpage URL needs to be transmitted after transmitting the corresponding application URL. In some embodiments, application detection module 208 may monitor error messages received from a client device after transmitting an application URL. If an error message is received from a client device, application detection module 208 identifies an application URL that was transmitted to this client device and retrieves a corresponding webpage URL. This webpage URL is then transmitted to the device. The webpage URL may be determined solely from information contained in the error message, which may include the initially transmitted application URL.

Alternatively, application detection module 208 may maintain a communication list identifying client devices and transmitted applications URLs. Whenever an error message is received from one of the client devices appearing on this list, application detection module 208 looks up the last application URL transmitted to this device and retrieves a corresponding application URL. In some embodiments, this list may be used to implement a learning function on service provider system 108. The learning function may aggregate information about applications present and absent on devices using this application selection service. This information in turn may be shared with content provider. It may be also used to recommend applications to users of client devices. Furthermore, it may be used for marketing purposes, such as tailor marketing content for transmission to client devices. Overall, this application selection service presents numerous commercialization opportunities.

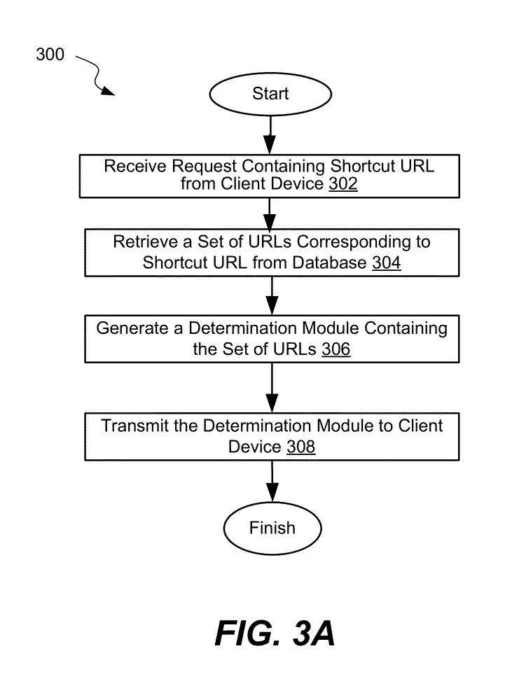

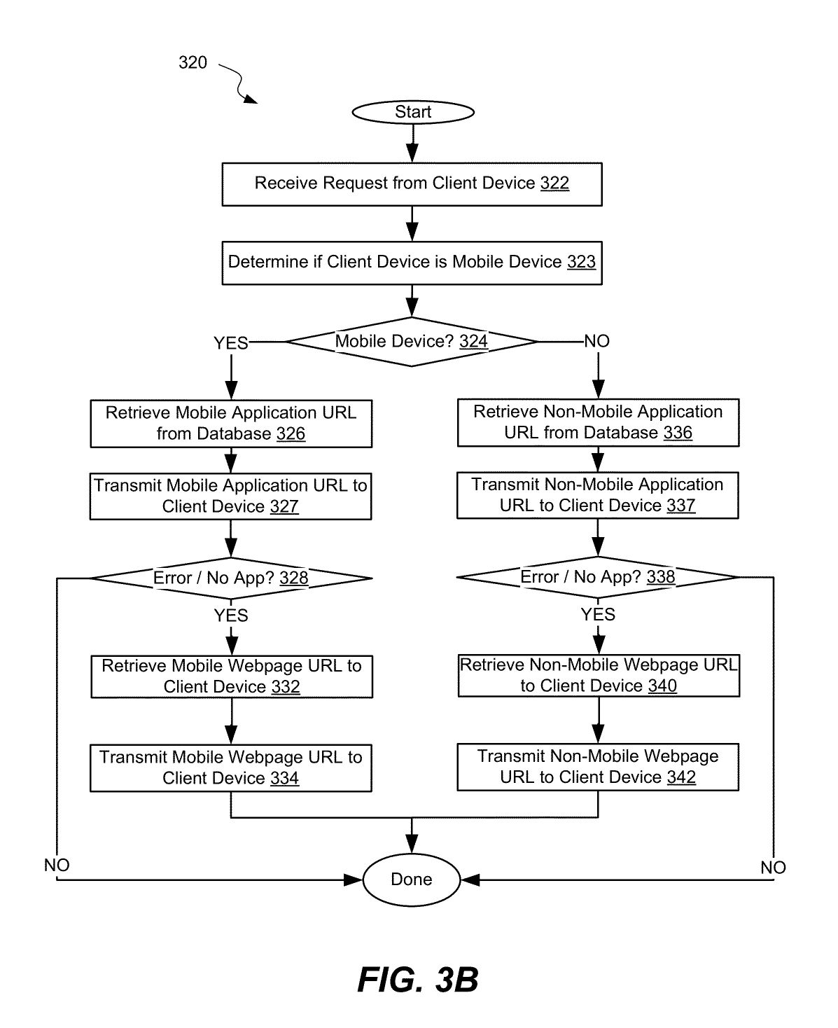

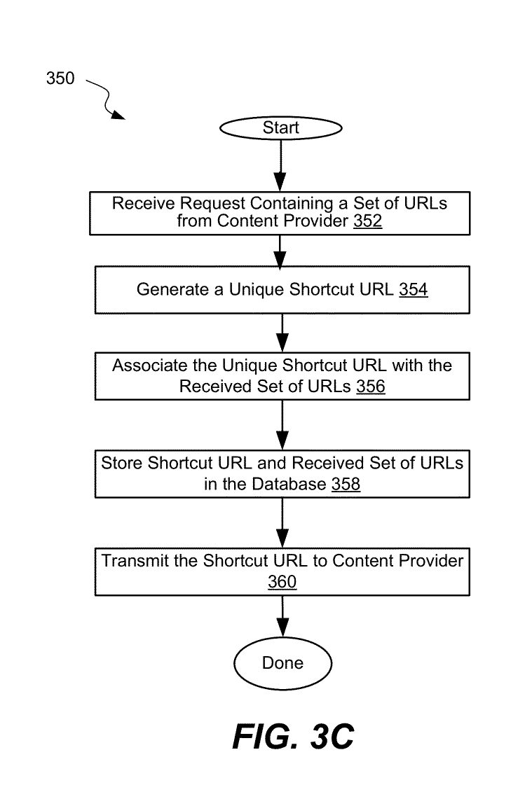

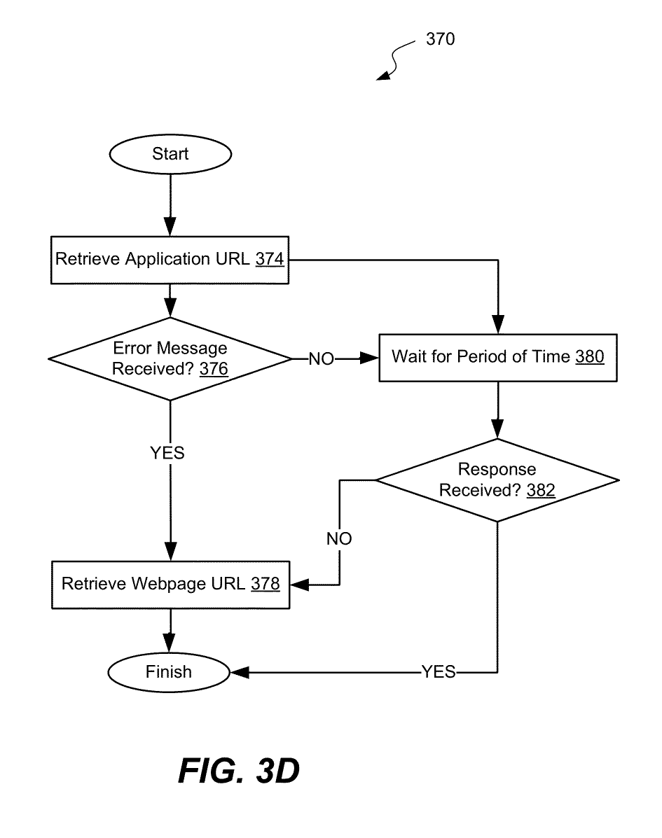

In some embodiments, some or all functions of application detection module are performed at the client device level. For example, URL packaging module 212 may create a determination module (further described below) that contains both application and webpage URLs and a logic for releasing these URLs in sequence to the client device. Various features of the determination modules are described below with reference to FIGS. 2B and 3D, for example.

While some examples described herein are referred to shortcut URLs, any other pointers may be issued as well. Shortcut URLs corresponding to application and webpage URLs of different content providers may be available from the same service provider. For example, multiple content providers may use the same service provider. Shortcut URLs may be indicative of the content providers or may be blinded by the service provider.

FIG. 2B is a schematic example of a determination module 220, in accordance with some embodiments. As described elsewhere in this disclosure, determination module 220 may be generated by a service provider system or, more specifically, by a URL packaging module of the service provider system after receiving a shortcut URL request from a client device or from a content provider server. Once generated, determination module 220 may be transmitted to the client device and is used by the client device to deliver one of more URLs contained in determination module 220. The determination module may be also stored at the server provide system for future uses. Specifically, determination module 220 may include mobile application URL 222, non-mobile application URL 224, mobile webpage URL 226, and non-mobile webpage URL 228. Various examples and descriptions of these URL types are presented below. In some embodiments, determination module includes fewer or more URLs. For example, when no mobile v. non-mobile differentiation is performed at the client device level, determination module 220 may include two URLs, i.e., application URL and webpage URL, instead of four URLs shown in FIG. 2B.

Determination module 220 may also include URL selection logic 232, which may determine the order and timing of URL retrieval from determination module 220. For example, when determination module 220 is received by the client device, URL selection logic 232 may determine whether the client device is a mobile device or a non-mobile device. This determination may be similar to functions of the client detection module described above with reference to FIG. 2A. If URL selection logic 232 determines that the client device is a mobile device, then URL selecting logic 232 may proceed with releasing mobile application URL 222 to the client device. This URL will attempt to activate a specific application on the client device. If this application is not available, then the device may generate an error message or do nothing. When URL selection logic 232 sees the error message it may proceed with releasing mobile webpage URL 226 to the client.

Even if the error message is not received, URL selection logic 232 may release mobile webpage URL 226 after a predetermined period of time. As such, URL selection logic 232 may include a timer in some embodiments. Mobile webpage URL 226 may open a browser on a background and display the requested content in the browser interface. If mobile application URL 222 was successful in activating the application, then this application will be opened on the foreground and will be blocked the web browser on the background. As such, a user will not see the browser interface in this situation and instead will view the content in the application interface. On the other hand, if mobile application URL 222 was not successful in activating the application (e.g., the application is not available on this client device), then the application will not appear on the foreground and the user will be able to see the web browser on the background. A similar process will be performed with non-mobile application URL 224 and non-mobile webpage URL 228, if URL selection logic 232 determined that the client device is a non-mobile device.

Determination module 220 may be implemented in Java script, flash/action script, browser plugin, and visual basic script. Other options for implementing determination module 220 are possible as well. Determination module 220 may also use an iFrame feature of HTML for splitting the interface into different frames.

### Selecting Applications Examples

FIG. 3A is a process flowchart corresponding to a method 300 of selecting an application available on a client device for viewing content, in accordance with some embodiments. Method 300 may commence with receiving a request from the client device during operation 302. The request may include a shortcut URL. In some, the shortcut URL is treated as a request. This request or, in some embodiments, the shortcut URL (operable as a request) may be used for retrieving a set of URLs corresponding to the shortcut URL during operation 304. The correspondence feature is described above with reference to FIGS. 2A. The retrieved set of URLs may include mobile and non-mobile URLs, e.g., mobile application URL, non-mobile application URL, mobile webpage URL, and non-mobile webpage URL.

The retrieved URLs may be then used to generate a determination module containing these URLs during operation 306. Various examples of determination module are described above with reference to FIG. 2B. The determination module is then transmitted to the client device during operation 308. This client device is typically the same client device that transmitted the request during operation 302.

FIG. 3B is a process flowchart corresponding to a method 320 of selecting an application available on the client device based on a URL received on the client device, in accordance with some embodiments. Method 320 may commence with receiving a request from a client device during operation 322. In some embodiments, the request may be in the form of HTTP GET command, which is a representation of the specified resource. Requests using GET retrieve data only and have no other effect. The request may be generated by the client device in response to activating the shortcut URL received on the client device. A communication module may be used during operation 322.

Separation of service provider URLs from application URLs and webpage URLs allow the same service provider to support multiple content providers. Distinctions among different content providers may be reflected at the next sub-domain level by adapting, e.g., actual first level sub-domains of the content providers. This allows some visibility of future directions and content associated with the service provider URL.

For example, the client device may receive a specifically generated URL that directs this client to transmit a request to the service provider system. This type of URL may be also referred to as a service provider URL. It should be noted that the service provider system does not have the content that a user of the client device is interested in. The content is provided by another system that is typically different from the service provider system. Furthermore, the service provider URL is different from an application URL and from a webpage URL. The application URL and the webpage URL point to the content provider system, while the service provider URL points to the service provider system. For example, top level domains and/or first level sub-domains may be different for the service provider URL.

Once the requests containing the service provide URL is received from the client device, method 320 may proceed with determining if this client device is a mobile device during operation 323. As described above, this determination may be performed by a client detection module. The detection may be based using a JavaScript for browser identification or a specific code. One example of such code is presented above. If it is determined that the client device is a non-mobile device (as reflected by decision block 324), then the process may proceed with a series of operations 336-342. Alternatively, if it is determined that the client device is a mobile device (as also reflected by decision block 324), then the process may proceed with a series of operations 326-334. The series of operations 336-342 and the series of operations 326-334 are conceptually the same and include retrieving application URLs, transmitting the retrieves application URLs to client devices, waiting for error messages, and in response to these error messages, retrieve and transmit webpage. However, the series of operations 336-342 deal with non-mobile application and webpage URLs, while the series of operations 326-334 deal with mobile applications URLs. Some of these operations may be optional and may be used if a corresponding URL is present. For example, operations 336-338 may be skipped if a non-mobile application URL is not present. In the same or another example, operations 340-342 may be skipped if a non-mobile webpage URL is not present. In some embodiments, For example, operations 326-328 may be skipped if a mobile application URL is not present. In the same or another example, operations 332-334 may be skipped if a mobile webpage URL is not present. Furthermore, operations 323-324 and the entire series of operations 336-342 or the series of operations 326-334 may be skipped and the method may deal only with mobile or non-mobile URLs.

For simplicity, only the series of operations 326-334 is described. One having ordinary skills in the art would understand that the same techniques may be applied to the series of operations 336-342. The series of operations 326-334 may proceed with retrieving a mobile application URL from the system's database. For example, the shortcut URL may be analysed to retrieve the corresponding mobile application URL. The table containing corresponding URLs (described above) may be used for this purpose.

The retrieved application URL is transmitted to the client device during operation 327. The application URL instructs the client to open a specific application associated with the content provider. For example, Amazon has Amazon Mobile applications available for iOS and Android systems. If the application is available on the client device, then this application is opened and requested content is accessed. Alternatively, if the application is not available on the client device generates an error message that is transmitted back to the service provider system (as reflected by the decision block 328).

In response to receiving the error, the service provider system will retrieve a corresponding webpage URL during operation 332. The webpage URL is then transmitted to the client device during operation 334. The client device uses this URL to open the corresponding webpage and retrieve the content.

In some embodiments, if the application is not available on the client device and the error message is received from the client device (see decision block 328), the system may offer the client device to download a corresponding mobile application. If this option is selected by the user, the client device may be redirected to a database containing the mobile application (e.g., Apple AppStore or Google Play). One the client device downloads the application some operations of method 320 may be repeated. Furthermore, the system may count a number of error messages received by a particular client device corresponding to absence of a particular application. This information may be used to offer a download of the application when the client devices receive a particular number of the error messages, which may be greater than one. Furthermore, this information may be shared (sold) to content providers as an indicator of their mobile applications' adoption.

### Shortcut URL Generation and Processing Examples

FIG. 3C is a schematic process flowchart corresponding to a method 350 for generating and processing shortcut URLs, in accordance with some embodiments. Method 350 may commence with receiving a request for a shortcut URL from a content provider during operation 352. The request may include a set of URLs, such as one or more application URLs and one or more webpage URLs. The request may be generated by the content provider in response, for example, to a user request to share content with one or more other users. Instead of transmitting a particular URL available to this particular user and determined by user's device and applications used to retrieve content, the content provider requests a shortcut URL that will be linked to all or some of available URLs for this content.

Once the request and corresponding URLs are received by the service provider system, it proceed with generating a unique shortcut URL during operation 354. As described above, the URL may be indicative of the received URLs. In other words, a user may be able to determine (e.g., guess) the content provider or type of content by examining a text string of the shortcut URL. Alternatively, a non-indicative shortcut URL (e.g., a random or sequential combinations of ASCII or Unicode characters may be used). In either case, each shortcut URL is unique.

In some embodiments, operation 354 may involve determining if any URLs received in the set have been previously associated with other shortcut URLs. This operation eliminates duplicate shortcut URLs for the same application and webpage URLs.

Method 350 may then proceed with associating the unique shortcut URLs with the received set of URLs during operation 356. This operation may be involved creating a new row entry into the table in the URL database of the service provider system. Other entries in this table may include a number times this shortcut URL has been used. During operation 358, the generated shortcut URL and associated set of received URLs is stored in the database.

At some point (operation 360), the shortcut URL is transmitted to the content provider that generated this request. It should be noted that operation 360 may be performed at any time after operation 354.

### Examples of Determination Module Operations

FIG. 3D is a schematic process flowchart corresponding to a method 370 implemented on a determination module, in accordance with some embodiments. Method 370 may be performed by the determination module when this module is received on the client device. Method 370 may start with retrieving application URL during operation 374. The determination module may then instruct the client device to use this application URL. After retrieval of the application URL, the determination module may wait for an error message as reflected by decision block 376. The error message may be generated if the client device does not have an application that can be activated by the application URL, for example.

If the error message is received, then the determination module proceeds with retrieving a webpage URL during operation 378. This webpage URL instructs the browser of the client device to retrieve the content and display the content on the browser.

If the error message is not received, then the client device may wait for a predetermined period of time as shown by operation 380. The determination module may continue waiting for either an error message or a response that the application activation (by the application URL) was successful as, e.g., shown by the decision block 382. If no such response was received, then the determination module proceeds with retrieving a webpage URL during operation 378 as described above. Alternatively, if the response that the application activation was successful is successful, then the method may complete.

The determination module may be also capable of distinguishing between mobile and non-mobile device, for example, prior to executing method 370 or during executing this method. Based on the type of the device, the determination module may select between mobile application and webpage URLs and non-mobile application and webpage URLs. In some embodiments, the type of the device is determined prior to generating a determination module and the module is only packed with a corresponding subset of URLs, e.g., with mobile application and webpage URLs if the client device is a mobile device or with non-mobile application and webpage URLs if the client device is a non-mobile device.

### Computer System Examples

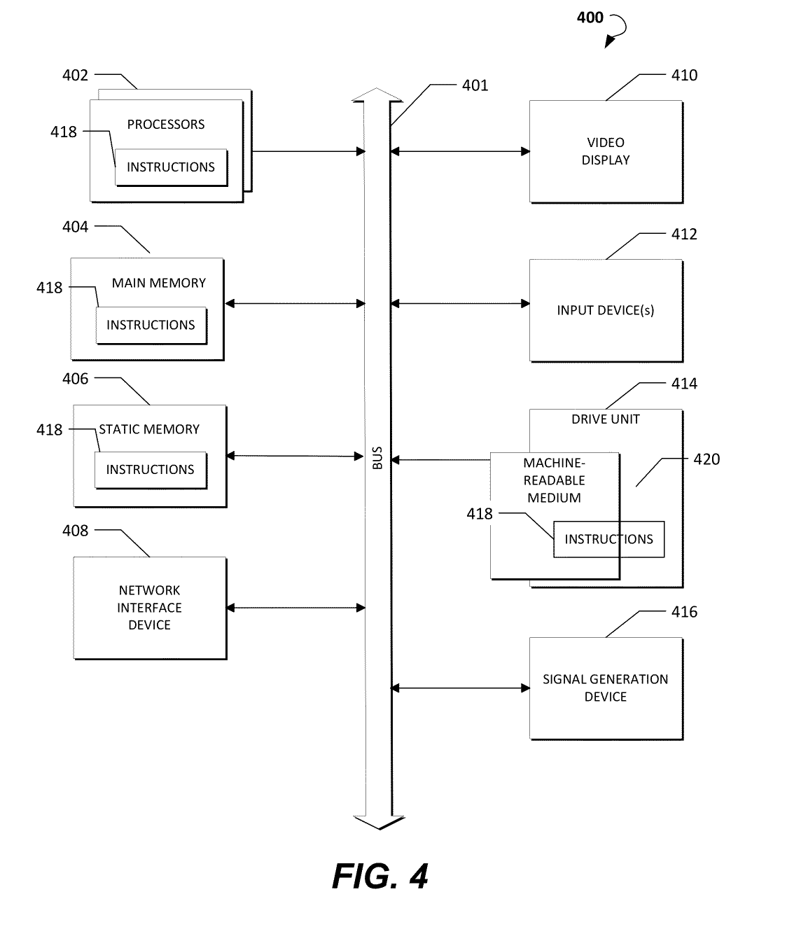

FIG. 4 shows a diagrammatic representation of a computer system (e.g., a client device or a service provider system), within which a set of instructions for causing the system to perform one or more of the methodologies discussed herein. In example embodiments, the computer system operates as a standalone device or can be connected (e.g., networked) to other systems, devices, and/or machines. In a networked deployment, the computer system can operate in the capacity of a server or a client in a server-client network environment, or as a peer node in a peer-to-peer (or distributed) network environment. The computer system is sometimes referred to as a machine and can be a personal computer (PC), a tablet PC, a set-top box (STB), a PDA, a cellular telephone, a web appliance, a network router, a switch, a bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 400 includes a processor or multiple processors 402 (e.g., a central processing unit (CPU), a graphics processing unit (GPU), or both), and a main memory 404 and a static memory 406, which communicate with each other via a bus 408. The computer system 400 can further include a video display unit 410 (e.g., a liquid crystal display (LCD) or cathode ray tube (CRT)). The computer system 400 also includes at least one input device 412, such as an alphanumeric input device (e.g., a keyboard), a cursor control device (e.g., a mouse), a microphone, a digital camera, a video camera, and so forth. The computer system 400 also includes a disk drive unit 414, a signal generation device 416 (e.g., a speaker), and a network interface device 418.

The disk drive unit 414 includes a computer-readable medium 420 which stores one or more sets of instructions and data structures (e.g., instructions 401) embodying or utilized by any one or more of the methodologies or functions described herein. The instructions 401 can also reside, completely or at least partially, within the main memory 404 and/or within the processors 402 during execution thereof by the computer system 400. The main memory 404 and the processors 402 also constitute machine-readable media.

The instructions 401 can further be transmitted or received over the network 120 via the network interface device 418 utilizing any one of a number of well-known transfer protocols (e.g., Hyper Text Transfer Protocol (HTTP), CAN, Serial, and Modbus).

While the computer-readable medium 420 is shown in an example embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media. Such media can also include, without limitation, hard disks, floppy disks, flash memory cards, digital video disks, random access memory (RAM), read only memory (ROM), and the like.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software programs for implementing the present method can be written in any number of suitable programming languages such as, for example, Hypertext Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Perl, UNIX Shell, Visual Basic or Visual Basic Script, Virtual Reality Markup Language (VRML), ColdFusion™ or other compilers, assemblers, interpreters or other computer languages or platforms.

### Conclusion

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present embodiments are to be considered as illustrative and not restrictive.

What is claimed is:

1. A method for selecting an application for displaying content, the method comprising:
receiving a request from a client device,
the request comprising a shortcut URL;
retrieving an application URL and a webpage URL corresponding to the shortcut URL;
generating a determination module,
the determination module comprising the retrieved application URL and the webpage URL; and
transmitting the determination module to the client device.

2. The method of claim 1, wherein the determination module further comprises a URL selection logic configured to retrieve, at the client device, the application URL and the webpage URL according to one or more rules.

3. The method of claim 2, wherein the one or more rules comprise retrieving the application URL when the determination module is received at the client device.

4. The method of claim 3, wherein the one or more rules comprise retrieving the webpage URL after retrieving the application URL and after receiving an error message from the client device.

5. The method of claim 3, wherein the one or more rules comprise retrieving the webpage URL at a time period after retrieving the application URL.

6. The method of claim 3, wherein the one or more rules comprise retrieving the webpage URL (a) at a time period after retrieving the application URL or (b) after retrieving the application URL and after receiving an error message from the client device.

7. The method of claim 3, wherein the one or more rules comprise retrieving the webpage URL (a) at a predetermination time after retrieving the application URL and (b) after retrieving the application URL and after receiving an error message from the client device.

8. The method of claim 1, wherein the determination module is implemented in one of Java script, lash/Application script, browser plugin, or Visual Basic (VB) script.

9. The method of claim 1, wherein the determination module is configured to execute the application URL on a foreground of a user interface of the client device and is further configured to execute the webpage URL on a background of the user interface of the client device.

10. The method of claim 1, wherein the application URL is a mobile application URL and the webpage URL is a mobile webpage URL,
the method further comprising retrieving a non-mobile application URL and a non-mobile webpage URL corresponding to the shortcut URL,
wherein the determination module further comprising the retrieved non-mobile application URL, the non-mobile webpage URL, and a URL selection logic for selecting among the mobile application URL, the mobile webpage URL, the non-mobile application URL, and the non-mobile webpage URL.

11. A method for selecting an application for displaying content, the method comprising:
(a) receiving a request from a client device, the request containing a shortcut URL;
(b) retrieving an application URL corresponding to the shortcut URL;
(c) transmitting the application URL to the client device;
(d) determining if an error code is received from the client device; and
(e) based on the determination, if the error code is received, retrieving and transmitting a webpage URL corresponding to the service provider URL.

12. The method of claim 11, wherein the shortcut URL, the application URL, and the webpage URL are stored in a database.

13. The method of claim 12, wherein the database comprises multiple application URLs and multiple webpage URLs associated with different content providers.

14. The method of claim 11, further comprising based on the determination, if the error code is received, directing the client device to an external database comprising an application corresponding to the mobile application URL.

15. The method of claim 11, further comprising repeating (a)-(d) and optionally (e) at least once.

16. The method of claim 11, further comprising determining from the received request if the client device is a mobile device and, if determined that the client device is not the mobile device, transmitting a non-mobile webpage URL and not performing (b)-(e).

17. The method of claim 11, further comprising receiving a plurality of application URLs and a plurality of webpage URLs and generating a corresponding plurality of shortcut URLs.

18. The method of claim 11, further comprising retrieving and transmitting a webpage URL corresponding to the service provider URL after a period of time after transmitting the application URL to the client device.

19. A service provider system for performing a method for selecting an application for displaying content, the service provider system comprising:
a communication module for receiving a request and an error message from a client device, the request containing a shortcut URL;
a client detection module for detecting if the client device is a mobile device;
an application detection module for retrieving an application URL corresponding to the shortcut URL or a webpage URL corresponding to the shortcut URL; and
a URL database comprising the shortcut URL, the application URL, and the webpage URL.

20. A machine readable medium having embodied thereon executable code, the executable code being executed by a processor for performing a method for selecting an application for displaying content, the machine readable medium comprising:
a code for receiving a request from a client device, the request containing a shortcut URL;
a code for retrieving a application URL corresponding to the shortcut URL;
a code for transmitting the application URL to the client device;
a code for determining if an error code is received from the client device; and
a code for based on the determination, if the error code is received, retrieving and transmitting a webpage URL corresponding to the service provider URL.
